(19) United States
(12) Patent Application Publication
(10) Pub. No.: US 2018/0200870 A1
(43) Pub. Date: Jul. 19, 2018

(54) Elastic Structure for Ratchet Wrench with Double Direction Switching Function and Method for Forming the Elastic Structure

(71) Applicant: Neng-Chia Shih, Lukang Township (TW)

(72) Inventor: Neng-Chia Shih, Lukang Township (TW)

(21) Appl. No.: 15/409,604

(22) Filed: Jan. 19, 2017

(51) Int. Cl. B25B 23/00; B25B 13/46; B21D 53/00; F16F 1/18

(52) U.S. Cl. CPC B25B 23/0007; F16F 1/185; B21D 53/00; B25B 13/463

(57) ABSTRACT

An elastic structure includes an elastic member. The elastic member includes a substantially T-shaped metal sheet that is bent to form an elastic plate presenting a successive S-shaped profile. The elastic plate has a first end formed with a planar resting portion and a second end integrally formed with a substantially U-shaped head. The U-shaped head has two symmetrically arranged limit side plates resting on two sides of the elastic plate. Each of the two limit side plates of the U-shaped head has a length at least extending to a middle position of the elastic plate.

### BACKGROUND OF THE INVENTION

### 1. Field of the Invention

The present invention relates to an elastic structure and, more particularly, to an elastic structure for a ratchet wrench with a double direction switching function and a method for forming the elastic structure.

### 2. Description of the Related Art

A conventional ratchet wrench in accordance with the prior art shown in FIG. 13 comprises a wrench body 30, a ratchet wheel 40, a pawl member 50, a control block 60, a resting boss 63 and a spring 62. The wrench body 30 has a first chamber 31 and a second chamber 32. The ratchet wheel 40 is mounted in the wrench body 30. The pawl member 50 is mounted in the first chamber 31 of the wrench body 30 and has a first side meshing with a toothed portion 41 of the ratchet wheel 40 and a second side provided with an arcuate face 51. The control block 60 is mounted in the second chamber 32 of the wrench body 30 and has a periphery provided with a slot 61. The resting boss 63 has a first end resting on the arcuate face 51 of the pawl member 50 and a second end received in the slot 61 of the control block 60. The spring 62 is received in the slot 61 of the control block 60 and is biased between the control block 60 and the resting boss 63 to push the resting boss 63 toward the pawl member 50. When in use, the control block 60 is rotated to control the resting boss 63 which selectively drives the pawl member 50 to press different sides of the first chamber 31, so as to produce a single-direction driving effect. In practice, the spring 62 and the resting boss 63 are clamped between the pawl member 50 and the control block 60, and the resting boss 63 is located between the arcuate face 51 of the pawl member 50 and the spring 62. However, when the control block 60 is rotated to switch the direction, the first end of the resting boss 63 slides on the arcuate face 51 of the pawl member 50, and the second end of the resting boss 63 sideward rubs the slot 61 of the control block 60, so that the resting boss 63 and the spring 62 are easily detached from the slot 61 of the control block 60, or produce distortion. In assembly, the control block 60 is initially mounted in the second chamber 32 of the wrench body 30 and is retained so that the control block 60 can be rotated only. Then, the spring 62 extends through the first chamber 31 and is inserted into the slot 61 of the control block 60, and the resting boss 63 is mounted on the spring 62. However, the opening of the first chamber 31 is directed toward the ratchet wheel 40, so that the spring 62 cannot be mounted easily. In addition, the spring 62 and the resting boss 63 have a smaller volume, so that the spring 62 and the resting boss 63 are easily lost or missed during assembly. Further, the spring 62 and the resting boss 63 are small, so that the spring 62 and the resting boss 63 are not assembled easily and conveniently.

### BRIEF SUMMARY OF THE INVENTION

In accordance with the present invention, there is provided an elastic structure comprising an elastic member. The elastic member includes a substantially T-shaped metal sheet that is bent to form an elastic plate presenting a successive S-shaped profile. The elastic plate has a first end formed with a planar resting portion and a second end integrally formed with a substantially U-shaped head. The U-shaped head has two symmetrically arranged limit side plates resting on two sides of the elastic plate. Each of the two limit side plates of the U-shaped head has a length at least extending to a middle position of the elastic plate.

In accordance with the present invention, there is further provided a method for forming an elastic member, comprising a first step of providing a substantially T-shaped metal sheet having a longitudinal portion and a transverse portion, a second step of bending the T-shaped metal sheet, with the longitudinal portion being perpendicular to the transverse portion, a third step of bending the longitudinal portion upward and downward in a reciprocating manner to form a successive S-shaped profile, and to construct an elastic plate by the longitudinal portion, and a fourth step of bending two sides of the transverse portion toward the longitudinal portion, to construct a substantially U-shaped head which has two sides resting on the elastic plate, to form two limit side plates, thereby forming an elastic member.

According to the primary advantage of the present invention, the elastic member includes the elastic plate and the U-shaped head which are formed integrally by the T-shaped metal sheet, and the elastic plate presents a successive S-shaped profile, thereby enhancing the elastic effect.

According to another advantage of the present invention, the U-shaped head is directly formed on one end of the elastic plate, thereby largely reducing the manufacturing time, saving the material and cost.

According to a further advantage of the present invention, the elastic member is formed integrally, so that the elastic member is mounted in the wrench body easily, quickly and conveniently.

According to a further advantage of the present invention, the U-shaped head of the elastic member has a larger area and contacts the pawl member in a plane-to-plane manner to increase the contact area between the U-shaped head of the elastic member and the pawl member, so that the elastic member engages the pawl member exactly, and the pawl member engages the ratchet wheel stably and actually.

According to a further advantage of the present invention, the U-shaped head has two limit side plates resting on two sides of the elastic plate to reinforce the structural strength of the elastic plate.

According to a further advantage of the present invention, the two limit side plates of the U-shaped head are received in the receiving space of the switching control member and press the switching control member, so that the U-shaped head is moved in concert with the switching control member synchronously.

According to a further advantage of the present invention, the two limit side plates of the U-shaped head protect the elastic plate to prevent the elastic plate from being deformed due to compression, thereby enhancing the lifetime of the elastic member.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a schematic view of a T-shaped metal sheet in accordance with the preferred embodiment of the present invention.

FIG. 2 is a schematic operational view of the T-shaped metal sheet as shown in FIG. 1 in working.

FIG. 3 is a schematic operational view of the T-shaped metal sheet as shown in FIG. 2 in working.

FIG. 4 is a schematic operational view of the T-shaped metal sheet as shown in FIG. 3 in working.

FIG. 5 is a perspective view of an elastic member in accordance with the preferred embodiment of the present invention.

FIG. 6 is an exploded perspective view of the elastic member for a ratchet wrench in accordance with the preferred embodiment of the present invention.

FIG. 7 is a top assembly view of the ratchet wrench as shown in FIG. 6.

FIG. 8 is a front cross-sectional assembly view of the ratchet wrench as shown in FIG. 6.

FIG. 9 is a partially exploded perspective view showing the elastic member for a for a pawl member having a different size.

FIG. 10 is a front cross-sectional assembly view of the ratchet wrench in accordance with another preferred embodiment of the present invention.

FIG. 11 is a top cross-sectional operational view showing the ratchet wrench is driven in the clockwise direction.

FIG. 12 is a top cross-sectional operational view showing the ratchet wrench is driven in the counterclockwise direction.

FIG. 13 is a top cross-sectional view of a conventional ratchet wrench in accordance with the prior art.

### DETAILED DESCRIPTION OF THE INVENTION

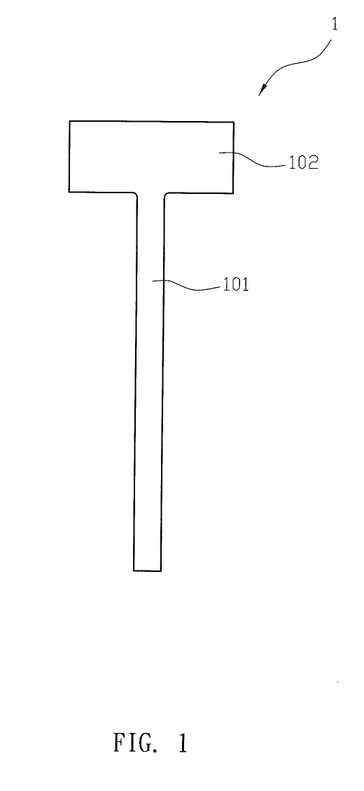

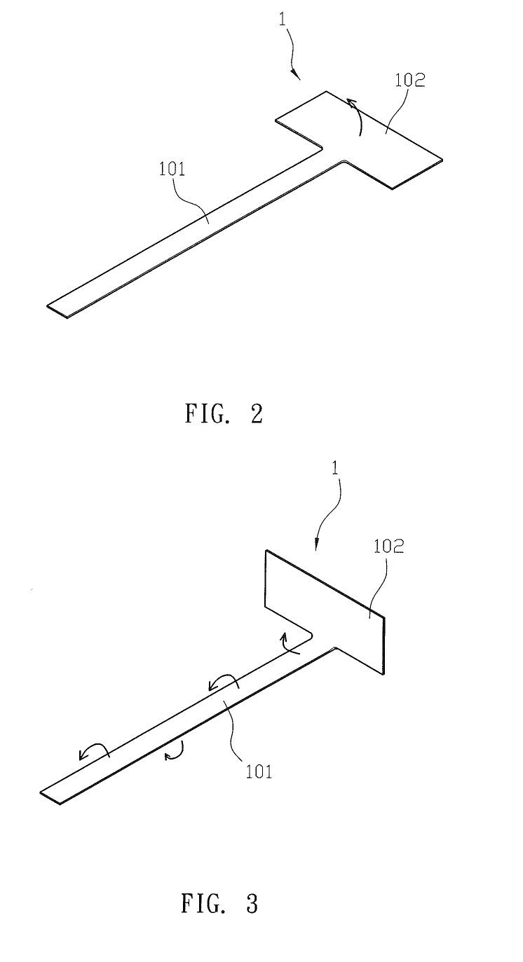

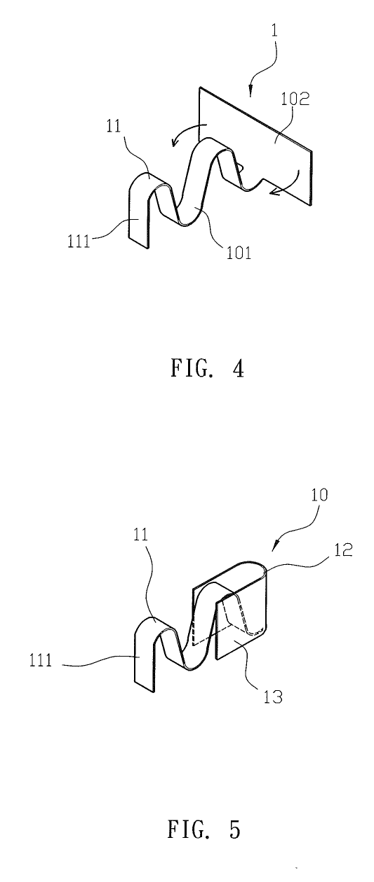

Referring to the drawings and initially to FIGS. 1-5, a method for forming an elastic member in accordance with the preferred embodiment of the present invention comprises a first step of providing a substantially T-shaped metal sheet 1 having a longitudinal portion 101 and a transverse portion 102 as shown in FIG. 1, a second step of bending the T-shaped metal sheet 1 as shown in FIG. 2, with the longitudinal portion 101 being perpendicular to the transverse portion 102 as shown in FIG. 3, a third step of bending the longitudinal portion 101 upward and downward in a reciprocating manner as shown in FIG. 3 to form a successive S-shaped profile, and to construct an elastic plate 11 by the longitudinal portion 101 as shown in FIG. 4, and a fourth step of bending two sides of the transverse portion 102 toward the longitudinal portion 101, to construct a substantially U-shaped head 12 which has two sides resting on the elastic plate 11, to form two limit side plates 13 as shown in FIG. 5, thereby forming an elastic member 10. The T-shaped metal sheet 1 is formed by a stamping process.

In the preferred embodiment of the present invention, the elastic structure includes an elastic member 10. The elastic member 10 includes a substantially T-shaped metal sheet 1 that is bent to form an elastic plate 11 presenting a successive S-shaped profile. The elastic plate 11 has a first end formed with a planar resting portion 111 and a second end integrally formed with a substantially U-shaped head 12. The U-shaped head 12 has two symmetrically arranged limit side plates 13 resting on two sides of the elastic plate 11. Each of the two limit side plates 13 of the U-shaped head 12 has a length at least extending to a middle position of the elastic plate 11. Preferably, the elastic plate 11 has a bending height that is limited to a height of each of the two limit side plates 13 of the U-shaped head 12.

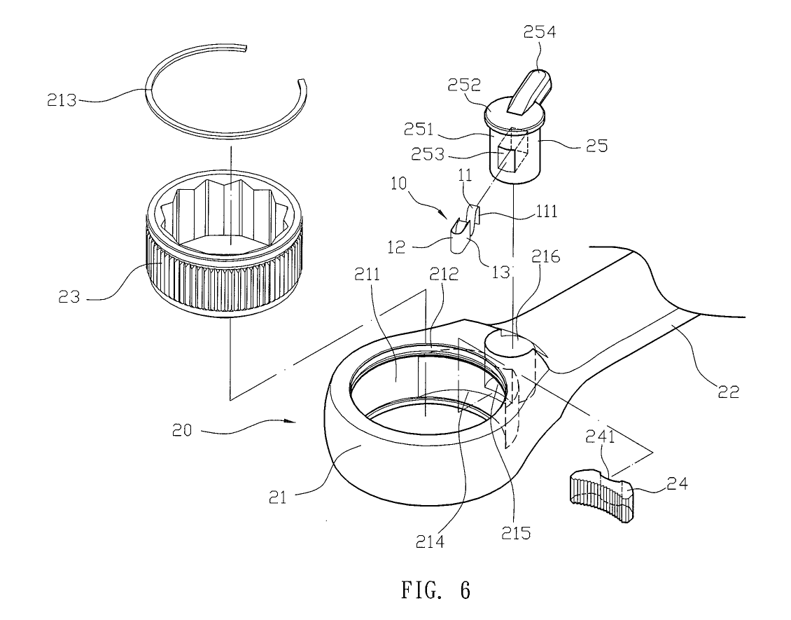

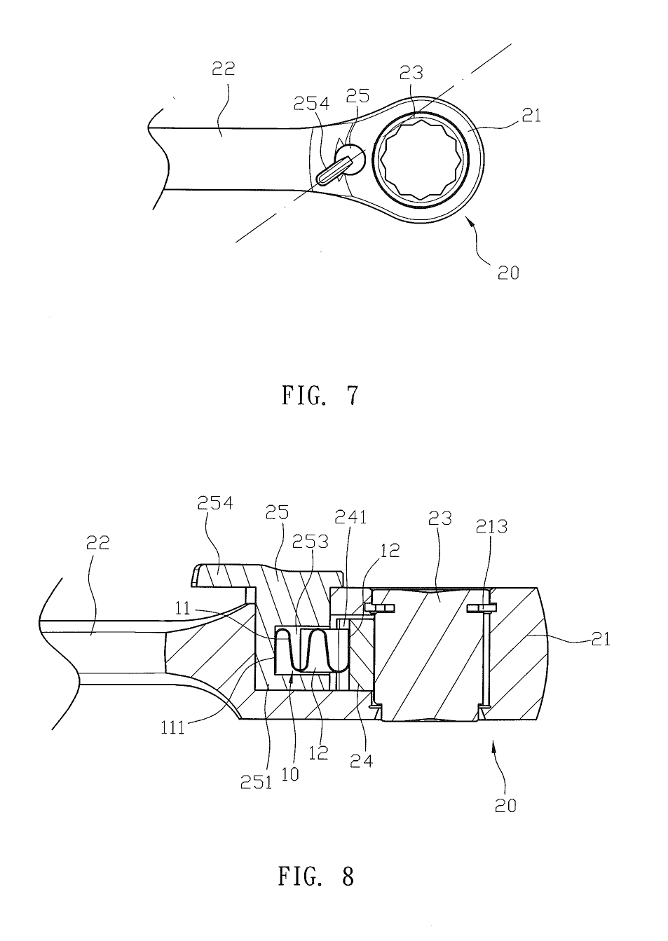

In practice, referring to FIGS. 6-8 with reference to FIGS. 1-5, the elastic member 10 is mounted on a ratchet wrench with a double direction switching function. The ratchet wrench includes a wrench body 20, a ratchet wheel 23, a pawl member 24, a switching control member 25, and a C-shaped snap ring 213. The wrench body 20 has a working portion 21 and a handle portion 22. The working portion 21 of the wrench body 20 is provided with a circular receiving recess 211 extending through a whole thickness of the working portion 21, an annular retaining groove 212 connected to the receiving recess 211, an arcuate receiving chamber 214 connected to the receiving recess 211, a passage 215 connected to the receiving chamber 214, and an opening 216 connected to the passage 215. The snap ring 213 is secured in the retaining groove 212 of the wrench body 20. The ratchet wheel 23 is mounted in the receiving recess 211 of the wrench body 20 and retained by the snap ring 213. The pawl member 24 is mounted in the receiving chamber 214 of the wrench body 20 and has a toothed first side meshing with the ratchet wheel 23 and a second side formed with an arcuate concave portion 241. The switching control member 25 is rotatably mounted on the wrench body 20. The switching control member 25 is provided with a shaft 251 mounted in the passage 215 of the wrench body 20 and a limit piece 252 protruding from the opening 216 of the wrench body 20. The shaft 251 of the switching control member 25 is provided with a receiving space 253 facing the receiving chamber 214 of the wrench body 20. The limit piece 252 of the switching control member 25 is provided with a drive knob 254 protruding outward therefrom.

In assembly, the elastic plate 11 of the elastic member 10 is mounted in the receiving space 253 of the switching control member 25, with the resting portion 111 of the elastic plate 11 resting on the wall of the receiving space 253. Then, the shaft 251 of the switching control member 25 extends through the opening 216 into the passage 215 of the wrench body 20. At this time, when the elastic member 10 is not subjected to an external force, the U-shaped head 12 of the elastic member 10 protrudes from the receiving space 253 of the switching control member 25 and extends into the receiving chamber 214 of the wrench body 20. Then, the pawl member 24 is mounted in the receiving chamber 214 of the wrench body 20, with the concave portion 241 resting on the U-shaped head 12 of the elastic member 10. Then, the ratchet wheel 23 is mounted in the receiving recess 211 of the wrench body 20. Finally, the snap ring 213 is secured in the retaining groove 212 of the wrench body 20 to retain the ratchet wheel 23 in the receiving recess 211 of the wrench body 20. Thus, assembly of the ratchet wrench is finished.

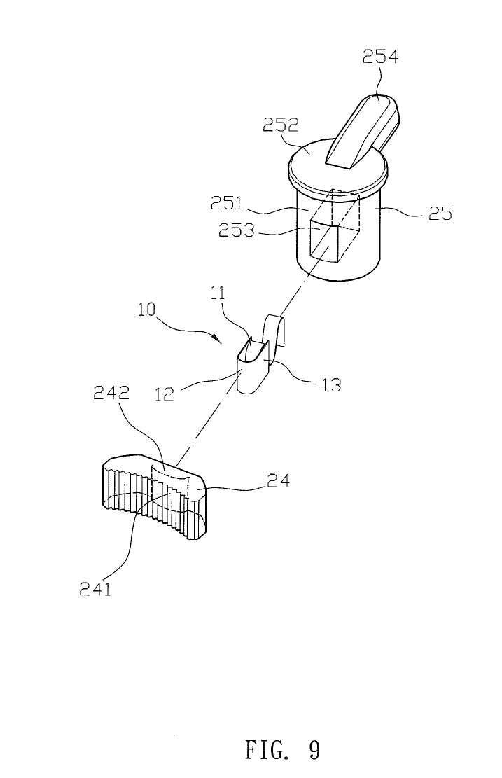

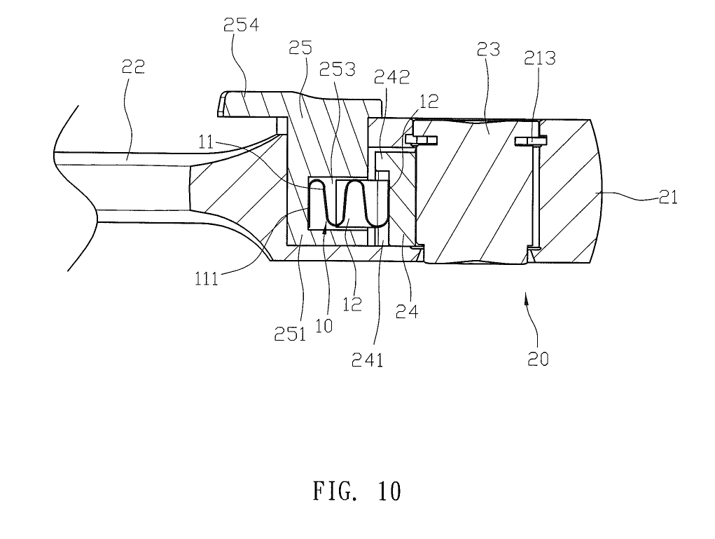

Referring to FIGS. 9 and 10, when the pawl member 24 is thicker, the arcuate concave portion 241 of the pawl member 24 has a side formed with a stop wall 242. In such a manner, the U-shaped head 12 of the elastic member 10 rests on the arcuate concave portion 241 of the pawl member 24 and is limited and positioned by the stop wall 242 of the pawl member 24, so that the elastic member 10 engages the pawl member 24 exactly and stably.

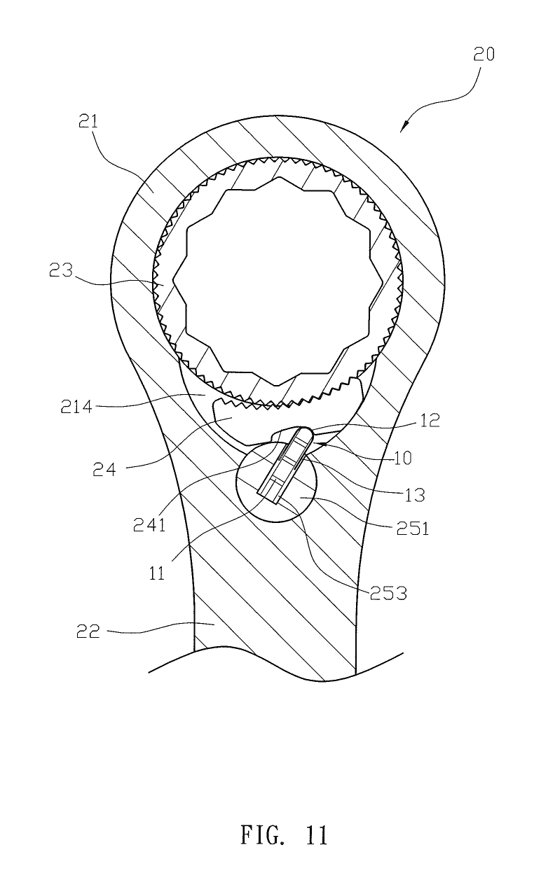

In operation, referring to FIG. 11 with reference to FIGS. 1-8, the switching control member 25 is switched rightward. At this time, the pawl member 24 pushes the ratchet wheel 23 and rests on a side wall of the receiving chamber 214 of the wrench body 20, so that the pawl member 24, the ratchet wheel 23 and the wrench body 20 are interlocked in the clockwise direction. In such a manner, when the wrench body 20 is rotated clockwise, the ratchet wheel 23 is also rotated clockwise, so as to drive a workpiece, such as a nut, bolt or the like, in the clockwise direction. On the contrary, when the wrench body 20 is rotated counterclockwise, the pawl member 24 is driven by the wrench body 20 to disengage the ratchet wheel 23, and the elastic member 10 is pressed and retracted inward, so that the ratchet wheel 23 is not rotated, and the wrench body 20 performs an idle rotation in the counterclockwise direction.

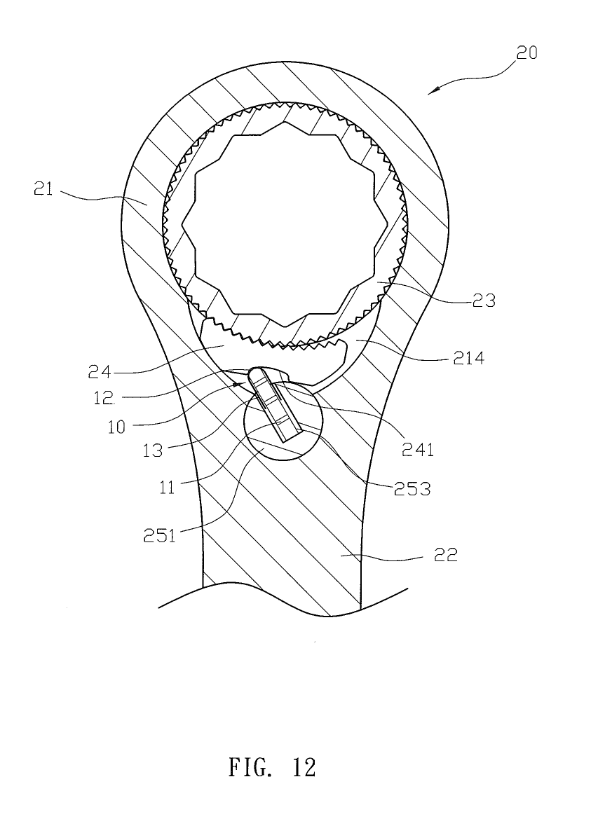

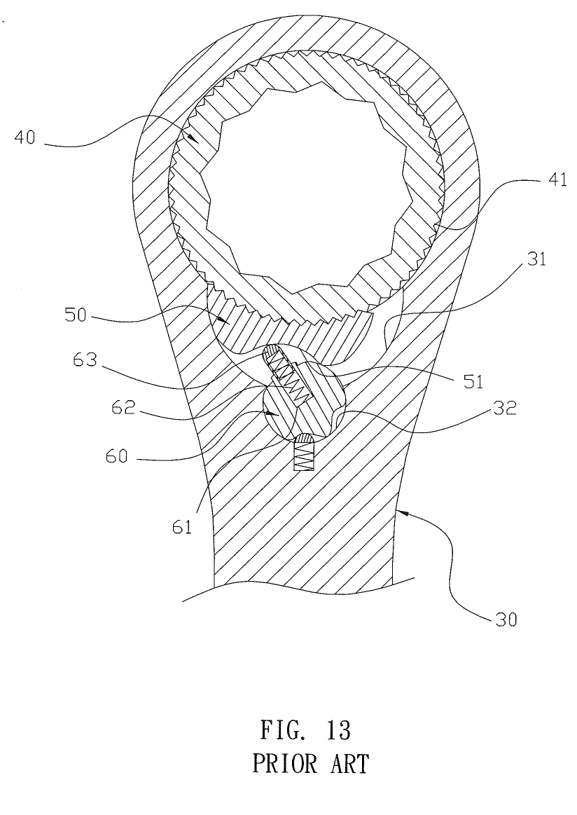

Alternatively, referring to FIG. 12 with reference to FIGS. 1-8, the switching control member 25 is switched leftward. At this time, the pawl member 24 pushes the ratchet wheel 23 and rests on another side wall of the receiving chamber 214 of the wrench body 20, so that the pawl member 24, the ratchet wheel 23 and the wrench body 20 are interlocked in the counterclockwise direction. In such a manner, when the wrench body 20 is rotated counterclockwise, the ratchet wheel 23 is also rotated counterclockwise, so as to drive the workpiece in the counterclockwise direction. On the contrary, when the wrench body 20 is rotated clockwise, the pawl member 24 is driven by the wrench body 20 to disengage the ratchet wheel 23, and the elastic member 10 is pressed and retracted inward, so that the ratchet wheel 23 is not rotated, and the wrench body 20 performs an idle rotation in the clockwise direction.

Accordingly, the elastic member 10 includes the elastic plate 11 and the U-shaped head 12 which are formed integrally by the T-shaped metal sheet 1, and the elastic plate 11 presents a successive S-shaped profile, thereby enhancing the elastic effect. In addition, the U-shaped head 12 is directly formed on one end of the elastic plate 11, thereby largely reducing the manufacturing time, saving the material and cost. Further, the elastic member 10 is formed integrally, so that the elastic member 10 is mounted in the wrench body 20 easily, quickly and conveniently. Further, the U-shaped head 12 of the elastic member 10 has a larger area and contacts the pawl member 24 in a plane-to-plane manner to increase the contact area between the U-shaped head 12 of the elastic member 10 and the pawl member 24, so that the elastic member 10 engages the pawl member 24 exactly, and the pawl member 24 engages the ratchet wheel 23 stably and actually. Further, the U-shaped head 12 has two limit side plates 13 resting on two sides of the elastic plate 11 to reinforce the structural strength of the elastic plate 11. Further, the two limit side plates 13 of the U-shaped head 12 are received in the receiving space 253 of the switching control member 25 and press the switching control member 25, so that the U-shaped head 12 is moved in concert with the switching control member 25 synchronously. Further, the two limit side plates 13 of the U-shaped head 12 protect the elastic plate 11 to prevent the elastic plate 11 from being deformed due to compression, thereby enhancing the lifetime of the elastic member 10.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An elastic structure comprising:
an elastic member;
wherein:
the elastic member includes a substantially T-shaped metal sheet that is bent to form an elastic plate presenting a successive S-shaped profile;
the elastic plate has a first end formed with a planar resting portion and a second end integrally formed with a substantially U-shaped head;
the U-shaped head has two symmetrically arranged limit side plates resting on two sides of the elastic plate;
the elastic plate is partially received in the U-shaped head and partially protrudes outward from the U-shaped head; and
each of the two limit side plates of the U-shaped head has a length at least extending to a middle position of the elastic plate.

2. The elastic structure of claim 1, wherein the elastic plate has a bending height that is limited to and lower than a height of each of the two limit side plates of the U-shaped head.

3. A method for forming an elastic member, comprising:
a first step of providing a substantially T-shaped metal sheet having a longitudinal portion and a transverse portion;
a second step of bending the T-shaped metal sheet, with the longitudinal portion being perpendicular to the transverse portion;
a third step of bending the longitudinal portion upward and downward in a reciprocating manner to form a successive S-shaped profile, and to construct an elastic plate by the longitudinal portion; and
a fourth step of bending two sides of the transverse portion toward the longitudinal portion, to construct a substantially U-shaped head which has two sides resting on the elastic plate, to form two limit side plates, thereby forming an elastic member, with the elastic plate partially received in the U-shaped head and partially protruding outward from the U-shaped head.

4. The method of claim 3, wherein the elastic plate has a bending height that is limited to and lower than a height of each of the two limit side plates of the U-shaped head.

5. The elastic structure of claim 1, wherein the U-shaped head forms a closed arcuate face.

6. The method of claim 3, wherein the U-shaped head forms a closed arcuate face.
